(19) United States
(12) Patent Application Publication
(10) Pub. No.: US 2002/0101387 A1
(43) Pub. Date: Aug. 1, 2002

(54) Dielectric loaded feed horn

(76) Inventor: Ronald J. Brandau, Lockport, IL (US)

Correspondence Address: JENKENS & GILCHRIST, P.C., 225 WEST WASHINGTON, SUITE 2600, CHICAGO, IL, 60606, US

(21) Appl. No.: 10/050,525

(22) Filed: Jan. 18, 2002

Related U.S. Application Data
(60) Provisional application No. 60/265,045, filed on Jan. 30, 2001.

(51) Int. Cl. H01Q 13/00

(52) U.S. Cl. 343/785; 343/786; 343/772

(57) ABSTRACT

A feed horn assembly has an elongated horn portion having an end aperture and a generally cylindrical metallic interior surface and an elongated dielectric rod portion substantially centered with respect to the horn portion and having an elongated tapered end part extending in the direction of the horn aperture is described. The same type of feed horn assembly with the cylindrical metallic portion removed so as to leave only the tapered dielectric rod to provide small blockage. The horn is designed so as to have a minimal diameter and length and yet can produce a symmetrical horn pattern with a substantially stationary phase center over a large bandwidth. The design procedure also allows maintenance of these symmetrical patterns over a large gain range (6 to 18 dbi).

### CROSS-REFERENCE TO RELATED APPLICATION

This application claims the benefit of priority of U.S. Provisional Patent Application Serial No. 60/265,045, filed Jan. 30, 2001.

### BACKGROUND OF THE INVENTION

This invention is directed generally to communication systems, and more particularly to a novel and improved feed horn design for use in microwave reflector-type antennas.

The present invention is illustrated and described below with reference to specific applications. In the first application, the horn is utilized as a feed horn in a “tri-band” offset prime-fed reflector-type antenna. In the specific application, the antenna operates in a 20 GHz band and a 30 GHz band for interactive communication with a satellite. Thus, the antenna both receives and transmits at 20 GHz and 30 GHz respectively through the satellite link. An additional 12 GHz band is also accommodated by the antenna for receiving satellite TV signals in this band from a satellite which is essentially co-located with the broadband internet satellite link.

The major problem in this offset tribunal antenna is that of maintaining a relatively constant phase center of the energy being radiated from the feed horn. In this regard, it is known that the phase center will generally move about somewhat as the frequency varies. For relatively narrow frequency bands, this generally does not present a significant problem. However, in the above-described application from 12 to 30 GHz, considerable shifting of the phase center may be experienced.

A major problem encountered in design of symmetrical dual reflector type antennas is the size of the feed horn element required for the frequency band or frequency bands to be utilized. Blockage of the energy to and from the reflector which is caused by the physical size or “shadow” of the radiating horn feed element can be detrimental to antenna performance. In this symmetrical dual reflector application, a frequency band of 5.925 to 7.125 GHz is typically employed. In this application, the problem of the physical size of the required feed horn is more significant than the problem of shifting phase center, which is relatively insignificant in this relatively narrow band.

### SUMMARY OF THE INVENTION

Briefly, in accordance with the foregoing, a feed horn comprises an elongated horn portion having a generally cylindrical metallic interior surface and an elongated dielectric rod portion which is substantially centered with respect to said horn portion and having an elongated tapered end part extending in the direction of the horn aperture is described. The horn is designed so as to have a minimal diameter and length and yet can produce a symmetrical horn pattern with a substantially stationary phase center over a large bandwidth The design procedure also allows maintenance of these symmetrical patterns over a large gain range (6 to 18 dbi).

### BRIEF DESCRIPTION OF THE DRAWINGS

In the drawings:

FIG. 1 shows a first embodiment of a feed horn for a tri-band antenna in accordance with one aspect of the invention;

FIG. 2 shows an embodiment of an antenna for a dual reflector-type antenna in accordance with another aspect of the invention;

FIGS. 3a and 3b show predicted patterns for the horn of FIG. 1 at various frequencies.

FIG. 4 shows an overlay of dielectric loaded and an equivalent corrugated metal type horns for this type of application;

FIGS. 5a, 5b and 5c show measured patterns for the feed of FIG. 2 at three frequencies; and

FIGS. 6a, 6b and 6c show predicted secondary patterns for the horn of FIG. 2.

### DETAILED DESCRIPTION OF THE ILLUSTRATED EMBODIMENT

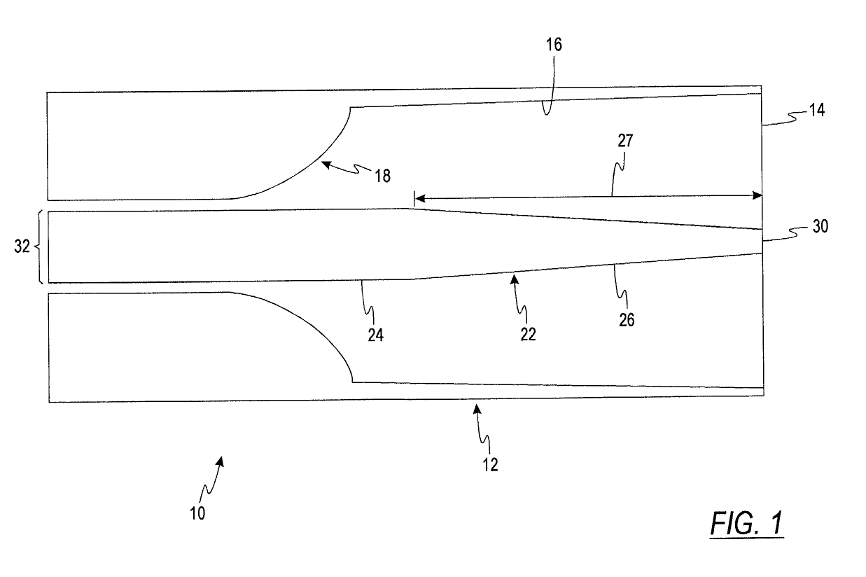

Referring now to the drawings, and initially to FIG. 1, a feed horn assembly for use in a reflector antenna is designated generally by the reference numeral 10 The embodiment of FIG. 1 is intended for use in a tri-band application, including 12 GHz, 20 GHz and 30 GHz bands, as discussed above. The horn assembly 10 includes a first horn element or portion 12 which defines an open outer end or aperture 14.

An inner surface of the horn 12 is metallic and has two portions. A first portion 16 is generally cylindrical, except for a slight taper which is left to allow for easy injection molding or other similar formation process for manufacturing the horn. Located inwardly of the first section 16 is a second section 18 which has an inwardly converging exponential type taper extending to the desired input bore of the horn.

A dielectric rod 22 is mounted concentrically with and centered with respect to the two sections 16, 18 of the horn. The dielectric rod 22 may be formed from various materials; however, for this example, a teflon-like material was selected having a dielectric constant of substantially 2.1 for this application. This material is relatively easy to mold or form to the desired shape.

A first portion 24 of the dielectric rod has a substantially constant outer diameter, whereas a second portion 26 is tapered inwardly as it proceeds in the direction of the aperture plane 14 of the horn 12. The end of the horn assembly 10 opposite the aperture plane 14 may be coupled with a waveguide (not shown).

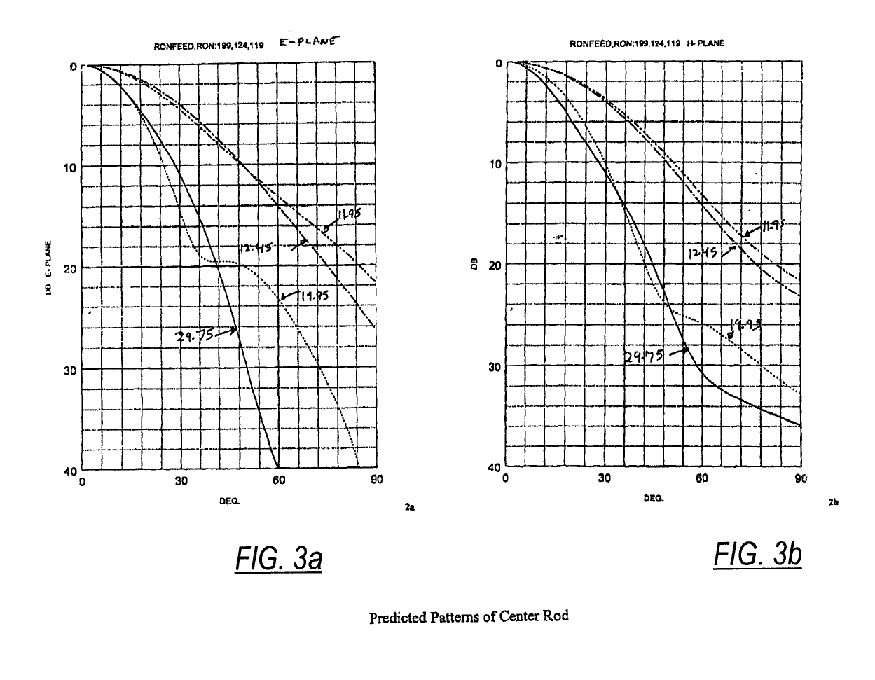

In the specific embodiment illustrated in FIG. 1, the parts thus far described have the following dimensions. The inner diameter of the horn aperture at the plane 14 is substantially 1.3 inches. This end does not necessarily terminate at the dielectric rod end. This factor could be used to further optimize the low band phase center if desired. The diameter of the narrow end 30 of the rod 22 is substantially 0.118 inches. The wide end 32 of the rod 22 is substantially 0.325 inches diameter, and the length of the tapered portion 26 of the rod is substantially 1.595 inches. This dimension is indicated generally by reference numeral by 27 in FIG. 1. It will be seen that the substantially cylindrically inner surface portion 16 of the horn 12 extends the full length of this taper 26, whereupon the exponential taper 18 of the inner surface of the horn 12 begins. We have found that the predicted patterns for the horn of FIG. 1 are as desired, as indicated generally in FIGS. 3a and 3b at various frequencies, including 11.95, 12.45, 19.95 and 29.75 GHz. In this regard, FIG. 3a illustrates E plane patterns and FIG. 3b illustrates H plane patterns.

Without limiting the invention to any particular theory of operation, the following is believed to describe the feed horn of FIG. 1. In the above-described tri-band application (12 GHz, 20 GHz and 30 GHz), it is believed that at the high frequency the energy is primarily, if not entirely in the dielectric rod 22, such that it behaves like a small diameter antenna of like diameter. At the low frequency end (12 GHz) the rod 22 has less influence whereupon the diameter of the feed is essentially the diameter at the horn aperture plane 14. Furthermore, we have predicted that the phase center for all three of the above-noted bands are essentially co-located at the aperture of plane 14.

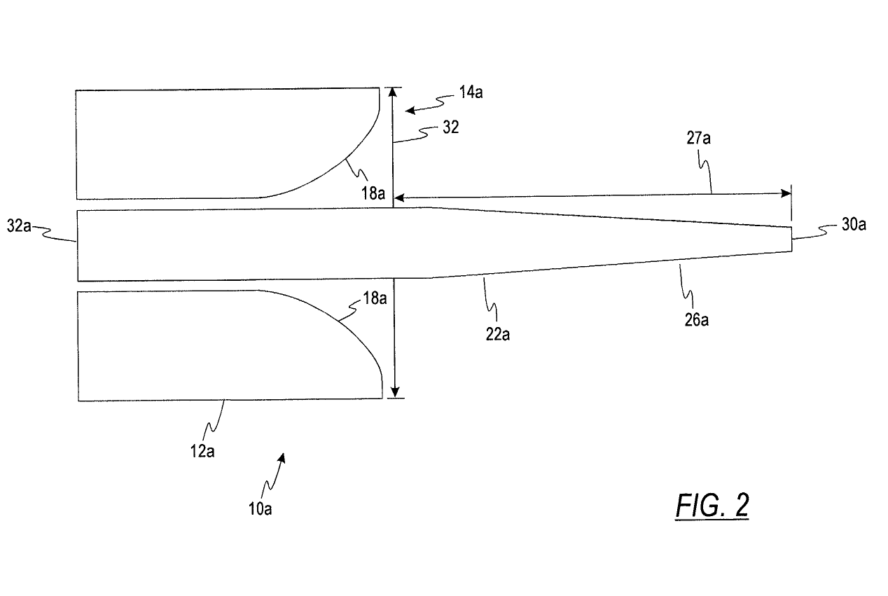

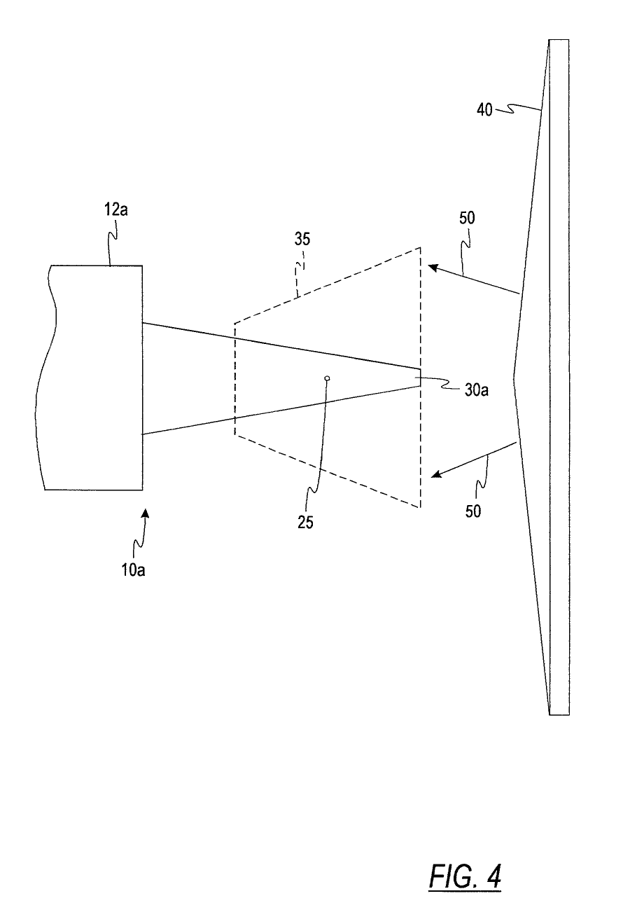

Referring next to FIG. 2, a similar feed horn structure 10a is shown. Like parts and components of the feed horn assembly 10a are indicated by like reference numerals to those used in FIG. 1, together with the suffix a. As mentioned above, this horn assembly is designed for use in a symmetrical dual reflector-type antenna assembly in a band from 5.925 to 7.125 GHz. In this application, the tip 30a of the dielectric rod 26a is spaced from the closest surface of a generally convex shaped sub reflector 40 (see FIG. 4) by a approximately 1.08 inches. However, here the first or cylindrical metallic inner portion 16 of the horn 12a is omitted, with the horn beginning essentially at the exponentially tapering surface portion 18a. Thus, the dielectric rod 22a extends outwardly of the aperture 14a, in the illustrated embodiment by approximately 6.00 inches. Also, the length 27a of the tapered portion 26a of the rod 22a is approximately 6.00 inches. The outer diameter of the aperture 14a, as indicated by reference numeral 40, is approximately 3.10 inches.

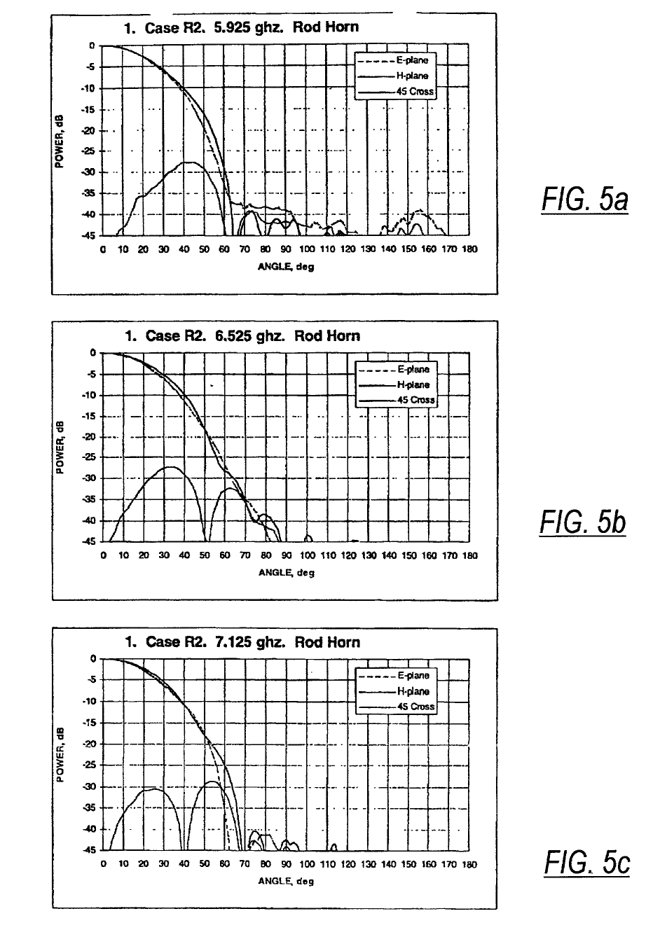

In the embodiment of FIG. 2, for use in a symmetrical dual reflector-type antenna application, at a frequency of 5.93-7.125 GHz, the energy exists almost entirely within the dielectric rod 22a The metal of the horn is “pulled back” to such an extent that it is essentially in the “shadow” of the dielectric rod, whereby it resembles a narrow diameter radiating element providing minimal blockage of the radiation pattern to and from the reflector or reflectors (e.g., subreflector 40—see FIG. 4). However, the assembly of FIG. 2 performs much like a corrugated metal horn of approximately 3 to 3.5 inches diameter. FIG. 4 shows an overlay of two horn types for this type of application. The blockage from the dielectric rod horn 10a of FIG. 2 is significantly reduced compared to a “conventional” metal corrugated horn 35a having the same phase center 25. The lines of radiation 50 from the subreflector 40 illustrate this Measured patterns for the horn of FIG. 2 are shown in FIGS. 5a through 5c, at various frequencies. Specifically, FIG. 5a shows patterns at 5.925 GHz, the low end of the above-mentioned band. FIG. 5b shows patterns at 6.525 GHz and FIG. 5c shows patterns at 7.125 GHz, the upper end of the band.

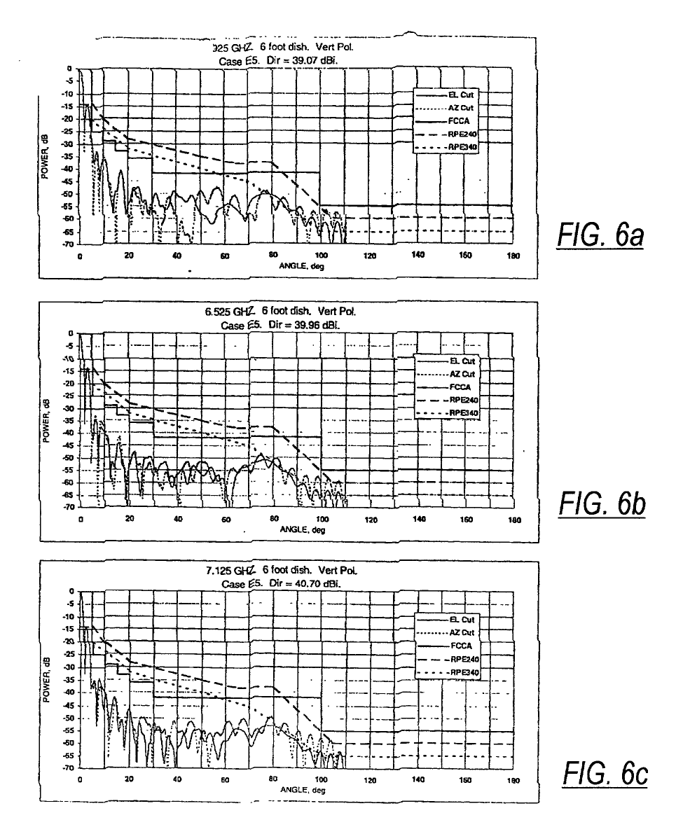

FIGS. 6a through 6c show predicted secondary patterns for the horn configured as in FIG. 2, and having a 6′ diameter parabolic reflector with an 18′ diameter subreflector at the same frequencies noted above for FIGS. 5a, 5b and 5c respectively. Subsequent measured secondary patterns agree with the predicted secondary patterns.

What has been described above is a feed horn assembly comprising an elongated horn portion having a generally cylindrical metallic interior surface and an elongated dielectric rod portion substantially centered with respect to said horn portion and having an elongated tapered end part extending in the direction of the horn aperture. The horn is designed so as to have a minimal diameter and length and yet can produce a symmetrical horn pattern with a substantially stationary phase center over a large bandwidth. The design procedure also allows maintenance of these symmetrical patterns over a large gain range (6 to 18 dbi). The above-described horns produce circularly symmetrical radiation patterns, have a substantially constant phase center over a large frequency range, and are small in size for a given pattern. It is noted that frequency scaling allows the above described operation in any other corresponding frequency bands.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

What is claimed is:

1. A feed horn comprising a horn portion having an end aperture and an interior surface portion defining an exponential taper converging inwardly and an elongated dielectric rod portion substantially centered with respect to said horn portion and having an elongated tapered end part extending in the direction of the horn aperture.

2. The feed horn of claim 1 wherein said horn has a generally cylindrical metallic interior surface portion which extends from said exponential taper and substantially encloses the tapered part of said dielectric rod, such that a free end of the rod is substantially coextensive with the plane of said aperture of said horn.

3. The feed horn of claim 2 wherein said interior surface portion having an exponential taper converges inwardly to an input bore of the horn portion.

4. The feed horn of claim 1 wherein said exponential taper begins and extends inwardly of said horn aperture, and wherein said dielectric rod tapered end part extends outwardly beyond said aperture.

5. The feed horn of claim 1 wherein the dielectric rod tapered end part extends such that said horn portion is substantially in a radiation shadow of the dielectric rod.

6. A feed horn which produces a symmetrical radiation pattern and has a substantially constant phase center over a wide frequency range, said feed horn Comprising:
a horn portion having an end aperture and an interior surface portion defining an exponential taper converging inwardly and an elongated dielectric rod portion substantially centered with respect to said horn portion and having an elongated tapered end part extending in the direction of the horn aperture.

7 The feed horn of claim 6 wherein said exponential taper begins and extends inwardly of said horn aperture, and wherein said dielectric rod tapered end part extends outwardly beyond said aperture.

8. The feed horn of claim 6 wherein the dielectric rod tapered end part extends such that said horn portion is substantially in a radiation shadow of the dielectric rod.

9. The feed horn of claim 6 wherein said frequency range in from about 12 GHz to about 30 GHz.

10. The feed horn of claim 6 wherein said frequency range is from about 5 GHZ to about 7 GHz.

11. A method of transmitting or receiving electromagnetic radiation using a feed horn assembly, said method comprising:
producing a symmetrical radiation pattern having a substantially constant phase center over a wide frequency range, using a horn portion having an end aperture and an interior surface portion defining an exponential taper converging inwardly and an elongated dielectric rod portion substantially centered with respect to said horn portion and having an elongated tapered end part extending in the direction of the horn aperture.

12. The method of claim 11 wherein said horn has a generally cylindrical metallic interior surface portion which extends from said exponential taper and substantially encloses the tapered part of said dielectric rod, such that a free end of the rod is substantially coextensive with the plane of said aperture of said horn.

13. The method of claim 12 wherein said interior surface portion having an exponential taper converges inwardly to an input bore of the horn portion

14. The method of claim 11 wherein said exponential taper begins and extends inwardly of said horn aperture, and wherein said dielectric rod tapered end part extends outwardly beyond said aperture.

15. The method of claim 11 wherein the dielectric rod tapered end part extends such that said horn portion is substantially in a radiation shadow of the dielectric rod.
